(19) United States
(12) Patent Application Publication
(10) Pub. No.: US 2015/0033562 A1
(43) Pub. Date: Feb. 5, 2015

(54) CARD HOLDER WITH BUILT IN CUTTER

(71) Applicant: Aletha Ann Posey, Peachtree City, GA (US)

(72) Inventor: Aletha Ann Posey, Peachtree City, GA (US)

(21) Appl. No.: 14/449,908

(22) Filed: Aug. 1, 2014

Related U.S. Application Data
(60) Provisional application No. 61/861,209, filed on Aug. 1, 2013.

(51) Int. Cl. B60R 22/32; B26B 27/00

(52) U.S. Cl. CPC B60R 22/32; B26B 27/00; B60R 2022/328
USPC 30/164; 30/298.4

(57) ABSTRACT

A card holder with a built in seatbelt cutter is provided. The present invention may include a back plate with an outer perimeter formed by a top end, a bottom end, a first side, and a second side. The back plate may include a cutout portion formed through the outer perimeter and into the back plate. The present invention may further include a cutter blade attached to the back plate and disposed within the cutout portion. The present invention may further include a card receptacle attached to the back plate that is sized to receive and secure a card within.

### CROSS-REFERENCE TO RELATED APPLICATION

This application claims the benefit of priority of U.S. provisional application No. 61/861,209, filed Aug. 1, 2013, the contents of which are herein incorporated by reference.

### BACKGROUND OF THE INVENTION

The present invention relates to card holders and seatbelt cutters and, more particularly, to a card holder with a built in seatbelt cutter.

A seatbelt cutter is extremely important because in many car, plane and train accidents the seatbelt could malfunction and jam due to the force of the crash and not come free from the buckle. Generally, people do not carry around seat belt cutters and a crash victim may not have a seatbelt cutter or access to one when needed.

As can be seen, there is a need for a convenient seatbelt cutter that may be carried around at all times.

### SUMMARY OF THE INVENTION

In one aspect of the present invention, an apparatus comprises: a back plate comprising an outer perimeter formed by a top end, a bottom end, a first side and a second side, wherein a cutout portion is formed through the outer perimeter and into the back plate; a cutter blade attached to the back plate and disposed within the cutout portion; and a card receptacle attached to the back plate and sized to receive and secure a card within.

These and other features, aspects and advantages of the present invention will become better understood with reference to the following drawings, description and claims.

### BRIEF DESCRIPTION OF THE DRAWINGS

FIG. 1 is a front perspective view of the present invention;

FIG. 2 is a rear perspective view of the present invention;

FIG. 3 is an exploded view of the present invention;

FIG. 4 is a section view of the present invention, taken along line 4-4 in FIG. 1; and

FIG. 5 is a section view of the present invention

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes an Identification (ID) Badge holder with a built in emergency seat belt cutter. The present invention lowers the chance of forgetting an emergency seat belt cutter because it is built in to the ID holder which holds an ID or other cards. The present invention goes from an ID holder to seat belt cutter in seconds. The back plate may be made of a strong plastic, injection molded, into front and back halves. The cutter may be made of stainless steel. The cutter may be sandwiched between the two halves before gluing.

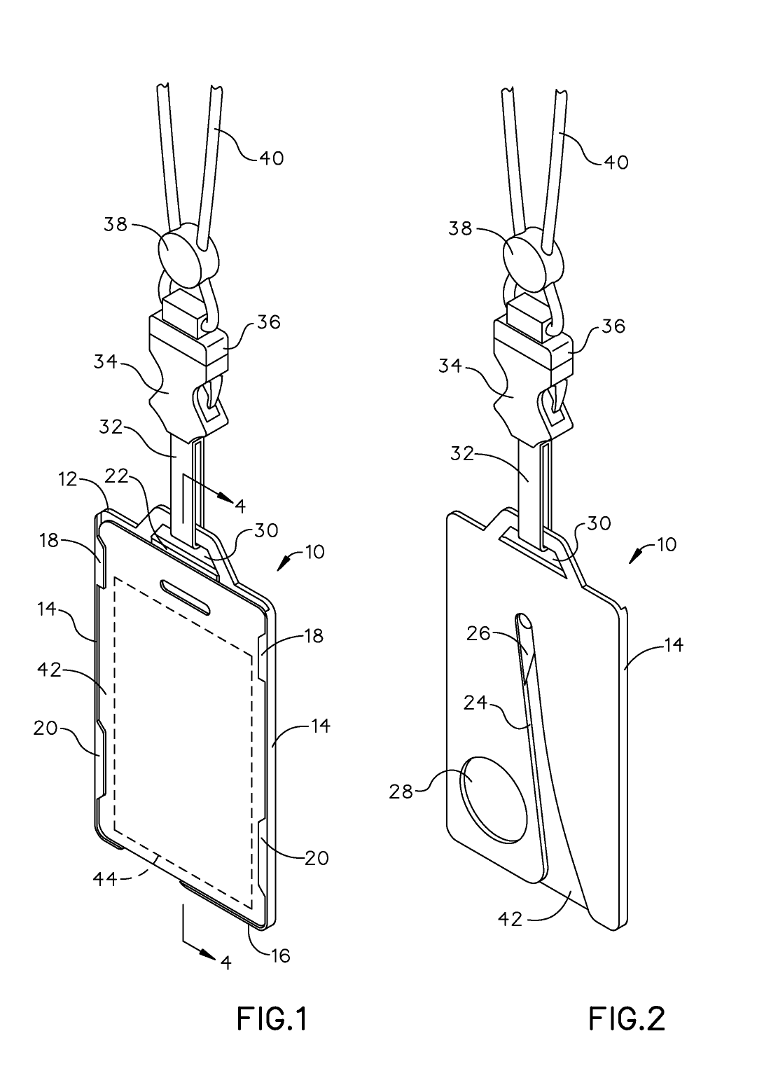

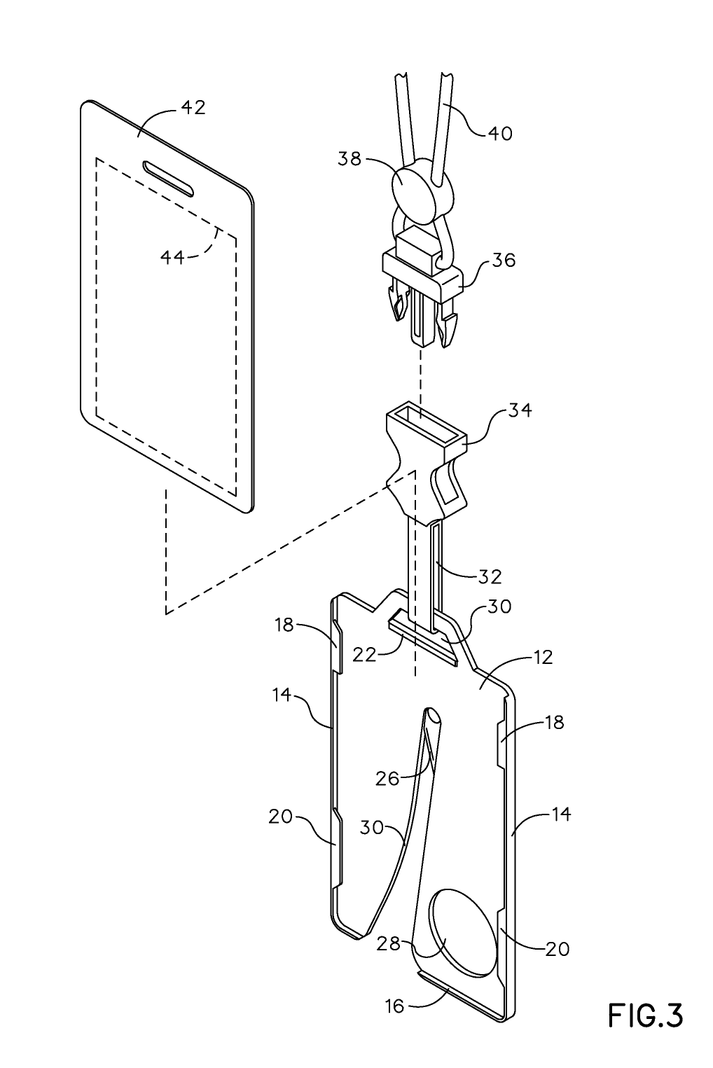

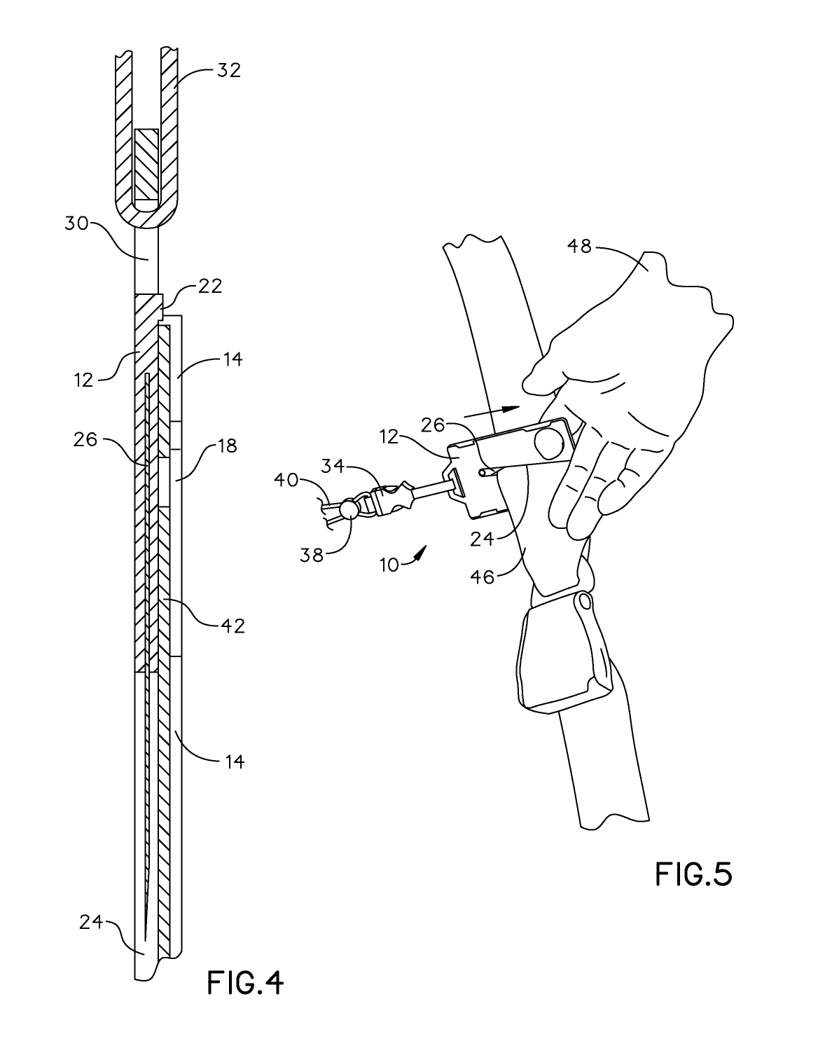

Referring to FIGS. 1 through 5, the present invention includes a card holder with a built in seatbelt cutter 10. The present invention may include a back plate 12 with an outer perimeter formed by a top end, a bottom end, a first side, and a second side. The back plate 12 may include a cutout portion 24 formed through the outer perimeter and into the back plate 12. The present invention may further include a cutter blade 26 attached to the back plate 12 and disposed within the cutout portion 24. The present invention may further include a card receptacle attached to the back plate that is sized to receive and secure a card 42 within.

In certain embodiments, the cutout portion 24 may extend through the bottom end of the outer perimeter and direct towards the top end. The cutout portion 24 may be shaped similar to a seatbelt cutter. For example, the cutout portion 24 may have an elongated and narrow shape, having a larger opening entrance and tapering from the bottom end to the top end. The blade 26 of the present invention may be disposed in the cutout portion 24 near the top end. The back plate 12 may further include a finger hole 28 therethrough. Therefore, a user may place their finger through the finger hole 28, place a seatbelt 46 within the cutout portion 24 and cut the seatbelt 46 with the blade 26.

The present invention may be attached to a cord 40 and may be worn around a user's neck to display the identification information 44 disposed on the card 42. In such embodiments, the present invention may include a slot 30 formed near the top end of the back plate 12. The slot 30 may receive a strap 32. The strap 32 may be attached to a female buckle 34. A cord 40 may be attached to a male buckle 36 that releasably attaches to the female buckle 34. The cord 40 may include a cord adjuster 38. The user may easily attach and detach the back plate 12 to the cord 40.

As mentioned above, the card receptacle of the present invention is formed to receive and secure a card 42. The card receptacle may include a rim 14, 16 extending from the back plate 12. The rim 14, 16 may include side rims 14 disposed on the first and second sides, and a bottom rim 16 disposed on the bottom side. The rim 14, 16 may form the receptacle in between to contain the card 42. In certain embodiments, a pair of upper tabs 18 may protrude from the side rims 14 near the top end and a pair of lower tabs 20 may protrude from the side rims 14 near the bottom end. The upper and lower tabs 18, 20 may retain the card 42 within the receptacle. The present invention may further include a top tab 22 protruding from the top end of the perimeter. The top tab 22 may have a smaller height than the rim 14, 16 so that the card 42 may be easily inserted into the card receptacle and removed from the card receptacle through the top end.

A method of using the present invention may include the following. A user 48 may insert the card 42 through the top end of the back plate 12 and into the card receptacle. The rims 14, 16 and the tabs 18, 20 may retain the card 42 within the card receptacle. The user 48 may then clip the female buckle 34 into the male buckle 36 and place the cord 40 around the user's neck 48. The identification information 44 of the card 42 may be displayed through the receptacle. If the user 48 is in a car accident and needs to use a seatbelt cutter, the user 48 may first remove the card 42 by sliding the card 42 out from the top end. The user may then place their finger within the finger hole 28 and place the seatbelt within the cutout portion 24. The user 48 may then pull the back plate 12 towards the seatbelt 46 so that the blade 26 may properly cut through the seatbelt 46. Aside from cutting through jammed seat belts 46 (transportation fields), the present invention may be used in medical situations such as cutting clothing in emergencies.

It should be understood, of course, that the foregoing relates to exemplary embodiments of the invention and that modifications may be made without departing from the spirit and scope of the invention as set forth in the following claims.

What is claimed is:

1. An apparatus comprising:
a back plate comprising an outer perimeter formed by a top end, a bottom end, a first side and a second side, wherein a cutout portion is formed through the outer perimeter and into the back plate;
a cutter blade attached to the back plate and disposed within the cutout portion; and
a card receptacle attached to the back plate and sized to receive and secure a card within.

2. The apparatus of claim 1, wherein the cutout portion extends through the bottom end of the outer perimeter.

3. The apparatus of claim 1, wherein the back plate comprises an attachment slot disposed near the top end and formed to receive a strap.

4. The apparatus of claim 1, wherein the back plate comprises a finger hole therethrough, sized to fit a finger.

5. The apparatus of claim 1, wherein the card receptacle comprises a rim extending from the first side, the second side, and the bottom end, wherein the rim comprises at least one tab protruding inward toward the back plate, wherein the card fits in between the back plate, the rim and the at least one tab.

6. The apparatus of claim 5, further comprising upper tabs protruding from the rim on the first side and the second side near the top end.

7. The apparatus of claim 6, further comprising lower tabs protruding from the rim on the first side and the second side near the bottom end.

8. The apparatus of claim 7, further comprising a top tab protruding from the top end of the perimeter.
